(19) United States
(12) Patent Application Publication
(10) Pub. No.: US 2026/0092683 A1
(43) Pub. Date: Apr. 2, 2026

(54) AUTOMATED REFINEMENT OF FLUID PROPERTIES FOR PRESSURE PULSE CALCULATION

(71) Applicant: Halliburton Energy Services, Inc., Houston, TX (US)

(72) Inventors: David Bennett, Houston, TX (US); Graham Peter Jack, Newburgh (GB)

(21) Appl. No.: 18/902,710

(22) Filed: Sep. 30, 2024

(51) Int. Cl. F17D 5/06; E21B 47/107

(52) U.S. Cl. CPC F17D 5/06; E21B 47/107

(57) ABSTRACT

A system can determine a first control point and a second control point in a flowline. The first control point can be located at a first location adjacent to a device for injecting a pressure pulse in the flowline, and the second control point can be located at a second location. The system can determine, based on a distance between the first location and the second location, a sampling rate. The system can determine, based on data sampled in the flowline at the sampling rate, an acoustic velocity of fluid in the flowline. The system can provide the acoustic velocity to the device for transmitting the pressure pulse to facilitate generating and transmitting, based on the acoustic velocity, the pressure pulse into the flowline.

### TECHNICAL FIELD

The present disclosure relates generally to flowline operations and, more particularly (although not necessarily exclusively), to automated refinement of fluid properties, such as acoustic velocity, for pressure pulse calculations to perform a diagnostic evaluation of a flowline.

### BACKGROUND

Flowline operations may include various equipment, components, methods, or techniques to perform various tasks, such as fluid control, with respect to a flowline, which may include a pipeline, a wellbore, or a combination thereof. In some examples, the flowline operations may involve evaluating a flowline to determine whether an anomaly exists in the flowline. In some examples, the anomaly may be or include a deposition of material, a blockage in the flowline, a leak in the flowline, etc. Determining a precise location, a precise magnitude, or a combination thereof, for example for repairing or maintaining the flowline, of the anomaly can be difficult. Additionally or alternatively, precisely determining the inputs for a calculation for determining information about the anomaly may be difficult.

### BRIEF DESCRIPTION OF THE DRAWINGS

FIG. 1 is a diagram of a flowline system that can use a pressure pulse injector that can use refined fluid properties for a pressure pulse calculation according to some aspects of the present disclosure.

FIG. 2 is a block diagram of a pressure pulse injection system that can inject a pressure pulse into a flowline based on refined fluid properties, such as acoustic velocity, according to some aspects of the present disclosure.

FIG. 3 is a block diagram of a computing system that can be used to refine fluid properties, such as acoustic velocity, for a pressure pulse injection calculation according to some aspects of the present disclosure.

FIG. 4 is a flowchart of a process for automatically refining fluid properties, such as acoustic velocity, for a pressure pulse injection calculation according to some aspects of the present disclosure.

FIG. 5 is a block diagram of a pressure pulse injection system that can inject a pressure pulse into a flowline based on refined fluid properties, such as acoustic velocity, determined using a mobile platform according to some aspects of the present disclosure.

### DETAILED DESCRIPTION

Certain aspects and examples of the present disclosure relate to automatically refining fluid properties, such as an acoustic velocity, for pressure pulse injection in a flowline. The flowline can be or include a wellbore, a pipeline, another type of conduit that can be sized to convey fluid with respect to a wellbore or a pipeline, with respect to a subterranean formation, etc., or any combination thereof. The pressure pulse injection can be performed by a pressure pulse injector or other suitable system or components that can pressurize fluid and direct the pressurized fluid into the flowline as a pressure pulse. The pressure pulse can be used to determine information about the flowline such as an anomaly or other feature of the flowline. For example, the pressure pulse may reflect off of the anomaly or other feature of the flowline, and the reflected pressure pulse may be received, such as by the pressure pulse injector, and interpreted to determine the information about the flowline. Generating the pressure pulse, interpreting the reflected pressure pulse, or a combination thereof may involve using a set of parameters to perform one or more calculations. The set of parameters can include an acoustic velocity for material within the flowline. The acoustic velocity may be used to determine an expected velocity of the pressure pulse in the flowline. An accurate determination of the acoustic velocity may enable accurate position identification for anomalies or other points of interest in the flowline.

Pressure calculations for determining information about anomalies, such as depositions, leaks, blockages, etc., or for object tracking may be dependent on using correct data for calculations. One challenge may be properly determining acoustic velocity of a fluid, such as a gas, a liquid, or a combination thereof, in an environment being analyzed such as within a flowline. While fluids can be sent externally for analysis to enhance accuracy, this may delay operations or prevent operations from using accurate and up-to-date information. For example, other systems may incorrectly identify a type, a location, a size, or other information about an anomaly, or other suitable feature of interest, in a flowline.

A system can perform operations for determining acoustic velocity of fluid and can enable an in-situ analysis to be performed. The system can support the determination of accurate fluid properties, such as acoustic velocity, density, viscosity, other suitable fluid properties, or any combination thereof at the time an analysis is being conducted. Examples of the analysis can include determining pressurization levels for a pressure pulse, determining information based on a reflected pressure pulse, other suitable analyses, or any combination thereof.

The system can identify control points and perform multiple calculations to determine fluid properties such as acoustic velocity, etc. For example, the system can identify or otherwise determine two control points for use in a calculation for acoustic velocity of a fluid in the flowline. The system can perform a time-of-flight measurement between the two control points to determine a time that it takes a pressure pulse or other suitable detectable wave to travel between the two control points. The time-of-flight calculation can involve determining a target resolution of distance for making the calculation. The target resolution may be adjusted, for example, by adjusting a sampling rate for measuring the pressure pulse or other detectable wave between the two control point. While the time-of-flight calculation is described, other suitable calculations for determining fluid properties for fluid within the flowline can be performed by the system.

In some examples, the system can automate the time-of-flight calculation, or other suitable calculations for determining the fluid properties, can automate determining the sampling rate, can automate other aspects of operations described herein, or any combination thereof. For example, the system can automate a determination of an observed acoustic velocity that can be used to determine distances within the flowline. Additionally or alternatively, the system can automate selection of an appropriate sample rate based on a distance or a distance resolution. Additionally or alternatively, the system can enable real-time adjustments for field conditions relating to acoustic velocity in the flowline. Additionally or alternatively, the system can receive or otherwise enable input for a target resolution or sampling rate for different distances in the flowline to one or more anomalies or to one or more other points of interest.

In some examples, the system may automate calibration of fluid properties for fluid within the flowline. Additionally or alternatively, the system can automate operations for determining information about anomalies, such as blockages, depositions, leaks, or a combination thereof. Automating the calibration, automation of the operations, or a combination thereof may enhance, compared to results of other systems, accuracy of outputs of the system. In some examples, a physical distance can be identified by the system, and the physical distance may extend between a pressure pulse injector and an anomaly or other point of interest in the flowline. The anomaly may be or include a pipeline pig that may be stuck in the flowline at a particular location. The system may perform operations to identify, such as within a certain number of meters or other physical distance, the particular location. In some examples, and instead of the anomaly or other point of interest in the flowline, the system may use a second pressure transducer positioned in the flowline apart from the pressure pulse injector or a first pressure transducer. The distance between the two pressure transducers can be used, along with properties of the fluid in the flowline, by the system to determine the appropriate sampling rate. Additionally or alternatively, the system may quantify the total potential distance, which may be defined as a flowline length, associated with the analysis.

In some examples, the system may measure a distance between two control points in the flowline. A first control point may be or include a pressure sensor, a flow meter, or another suitable device. In some examples, the first control point may be or include a known feature of the flowline, and the known feature may include a diameter change, a Tee, a Wye, or other known feature of the flowline. A second control point may be or include an additional pressure sensor, an additional flow meter, or another suitable device. In some examples, the second control point may include a known feature in the flowline that is a measured or known distance from the first control point. The system can use the first control point and the second control point, or, in some cases, any additional control points if available, to measure fluid properties in situ with respect to the flowline. The system can detect pressure via a pressure sensor that can be used for analysis. Additionally or alternatively, the system can detect temperature via a temperature sensor that may be positioned proximate to the pressure sensor. In some examples, line temperature variations in static or flowing conditions in the flowline can be detected, simulated based on external temperature changes and expected flow rates, or a combination thereof.

The system can use the detected pressures, temperatures, etc. to make a time-of-flight calculation or other suitable calculations. The calculations can be made by initiating a pressure pulse, observing the pressure pulse traveling past the first control point, observing the pressure pulse, or the reflection thereof, traveling past the first control point and the second control point, etc. In some examples, an elapsed time can be measure or determined between a time of the pressure pulse, or the reflection thereof, at the first control point and a time of the pressure pulse, or the reflection thereof, at the second control point. In some examples, the system can use the elapsed time to determine a sampling rate by dividing the flowline length by the target physical distance. For example, if the target physical distance is five feet, and the flowline is 60,000 feet, the sampling rate can be determined to be 12,000 samples per second, though other suitable examples are possible for the sampling rate. The sampling rate can be applied, for example automatically, to data acquisition equipment, such as pressure sensors, etc. of the pressure pulse injector.

In some examples, temperature, the observed or measured time-of-flight, other suitable inputs, or any combination thereof can be used to determine an acoustic velocity. The acoustic velocity may be or represent an expected velocity of a pressure pulse in the fluid within the flowline. The acoustic velocity can be used as an input for generating a pressure pulse, interpreting a reflected pressure pulse, or a combination thereof. For example, the acoustic velocity can be used to determine information about an anomaly in the flowline based on a reflected pressure pulse. Additionally or alternatively, the acoustic velocity may be used to facilitate or otherwise control an operation with respect to the flowline. For example, the acoustic velocity, or any value derived therefrom, may be used as an input for a repair or maintenance operation to fix or maintain at least a portion of the flowline.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

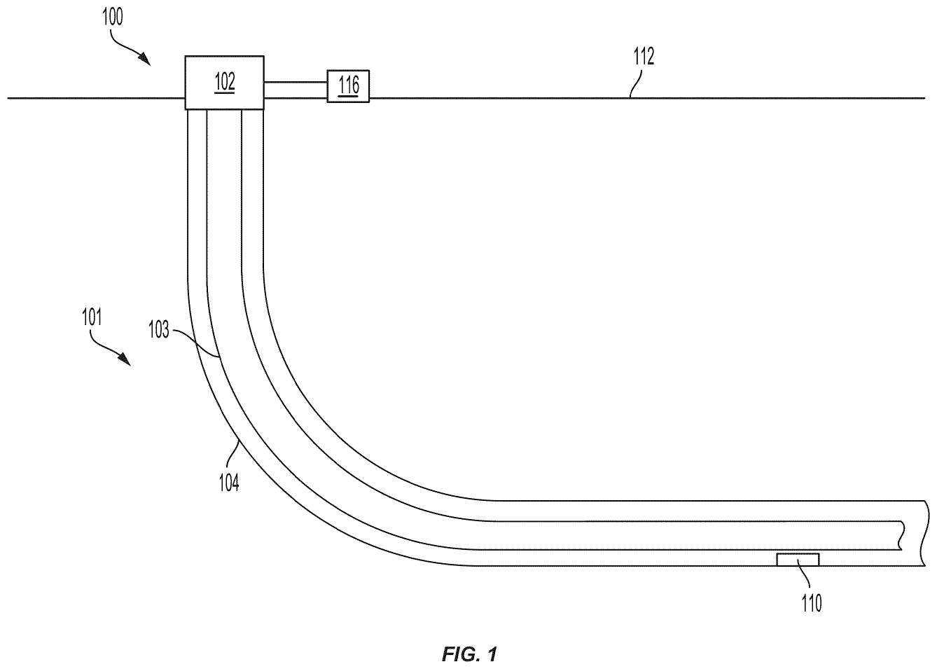

FIG. 1 is a diagram of a flowline system 100 that can use a pressure pulse injector 102 that can use refined fluid properties for a pressure pulse calculation according to some aspects of the present disclosure. In some examples, the flowline system 100 is illustrated for a pipeline 103 positioned in a wellbore 104, such as an oil or gas wellbore, for extracting fluids from a subterranean formation 101. For example, the wellbore 104 can be used to extract water, oil, gas, other suitable fluid or material, or any combination thereof from the subterranean formation 101. As illustrated, the wellbore 104 is formed in the subterranean formation 101, but the wellbore 104 can be formed in a sub-oceanic formation or in other suitable locations. The wellbore 104 can include the pipeline 103, which may be or include a casing or other suitable component for allowing produced fluid to be extracted from the wellbore 104.

In some examples, the flowline system 100 can include a well tool or downhole tool 122. The downhole tool 122 can be any suitable tool used to gather information about the wellbore 104, used to perform an operation in the wellbore 104, etc. For example, the downhole tool 122 can be a tool delivered downhole by wireline to perform operations such as wireline formation testing. Alternatively, the downhole tool 122 can include a completion tool, a stimulation tool such as a tool used for fracking, etc. In some examples, the downhole tool 122 can be used to deploy a sensing device or to otherwise deploy other suitable components in the wellbore 104. Additionally or alternatively, the downhole tool 122 can be, can include, or can be communicatively coupled to a repair or maintenance tool, such as a wellbore pig, that can be used to perform one or more operations in the wellbore 104 or the pipeline 103.

The wellbore 104, or the pipeline 103 positioned in the wellbore 104, may be a conduit for transporting fluid with respect to the flowline system 100. For example, the wellbore 104, or the pipeline 103, may produce hydrocarbon fluid from the subterranean formation 101, may transport mud, stimulation fluid, or other suitable fluid for use in the wellbore 104, in the pipeline 103, in the subterranean formation 101, or in a combination thereof, etc. Over time, an anomaly may form in the wellbore 104 or in the pipeline 103. For example, and as illustrated in FIG. 1, an anomaly 110 may form in the wellbore 104. In some examples, the anomaly 110 may be or include a leak, a deposition, an obstruction, other anomaly, or any combination thereof. A leak may involve a crack or other unintentional perforation in the wellbore 104 that can allow fluid to exit the wellbore 104 in unintended locations. A deposition may involve a build-up of material, such as paraffins or other damaging materials, on an inside of the wellbore 104. An obstruction may involve a partial or complete loss of flow through the wellbore 104, and an example of the obstruction can include a wellbore tool, such as an inline pig, become stuck in the wellbore 104.

The pressure pulse injector 102 can be used to evaluate the wellbore 104 or the pipeline 103. In some examples, the pressure pulse injector 102 can be used to determine information about the anomaly 110. The information about the anomaly 110 may include a location of the anomaly 110, a size of the anomaly 110, a type of the anomaly 110, or other suitable information about the anomaly 110. The pressure pulse injector 102 can determine one or more parameters for a pressure pulse and can inject the pressure pulse into the wellbore 104 or into the pipeline 103. For example, the pressure pulse injector 102 can determine a pressure change or a velocity change for fluid to be injected into the wellbore 104 or into the pipeline 103 for generating the pressure pulse without damaging any component of the flowline system 100. The pressure pulse may reflect in the wellbore 104 or in the pipeline 103, and the reflected pressure pulse may be received by the pressure pulse injector 102. The reflected pressure pulse may be analyzed, for example by the pressure pulse injector 102 or a computing device associated with the pressure pulse injector 102, to determine whether the anomaly 110 exists and, if the anomaly 110 is detected, information, such as a location, a size, etc., about the anomaly 110.

In some examples, the pressure pulse injector 102, or the control system 116 thereof, may determine an acoustic velocity or other suitable parameters about fluid within the wellbore 104 or in the pipeline 103. For example, the pressure pulse injector 102, or the control system 116 thereof, may identify or determine at least two control points and a sampling rate, and the pressure pulse injector 102, or the control system 116 thereof, may use the control points and the sampling rate to measure the acoustic velocity or the other suitable parameters about the fluid. The acoustic velocity or the other suitable parameters about the fluid can be used to determine values for, or generate, the pressure pulse. Additionally or alternatively, the acoustic velocity can be used as an input to determine the information about the anomaly 110.

In some examples, and as illustrated in FIG. 1, the pressure pulse injector 102 can be positioned at a surface 112 of the flowline system 100. While the pressure pulse injector 102 is illustrated as being positioned at the surface 112, in other examples, the pressure pulse injector 102 may be positioned in other suitable locations such as at a remote location, within the wellbore 104 or the pipeline 103, etc. Additionally or alternatively, the pressure pulse injector 102 may be communicatively coupled with a control system 116 that can be or include a computing device. The control system 116 may receive data, such as geometric conditions of the wellbore 104 or the pipeline 103, operating conditions of the wellbore 104 or the pipeline 103, or other suitable data, and the control system 116 may determine one or more parameters about a pressure pulse to inject into the wellbore 104 or the pipeline 103. The one or more parameters may include a pressure change, a velocity change, or other suitable parameters that can be adjusted to adjust the pressure pulse to be injected. In some examples, the control system 116 may be included in, such as within a common housing as, the pressure pulse injector 102.

While FIG. 1 illustrates the pressure pulse injector 102 being used with respect to the wellbore 104 that can include the pipeline 103, in other examples, the pressure pulse injector 102 may be used with a surface pipeline or other suitable flowline that may be positioned to convey fluid at least partially at the surface 112. For example, a surface pipeline may be positioned at the surface 112 to convey produced hydrocarbon material from the wellbore 104 to a remote location, for example for refine or further processing. The pressure pulse injector 102, or the control system 116 thereof, may determine an acoustic velocity or other suitable parameters about fluid within the surface pipeline. For example, the pressure pulse injector 102, or the control system 116 thereof, may identify or determine at least two control points along the surface pipeline and an associated sampling rate, and the pressure pulse injector 102, or the control system 116 thereof, may use the control points and the associated sampling rate to measure the acoustic velocity or the other suitable parameters about the fluid in the surface pipeline. The acoustic velocity or the other suitable parameters about the fluid in the surface pipeline can be used to determine values for, or generate, the pressure pulse for injection into the surface pipeline to identify an anomaly in the surface pipeline. Additionally or alternatively, the acoustic velocity can be used as an input to determine the information about the anomaly in the surface pipeline.

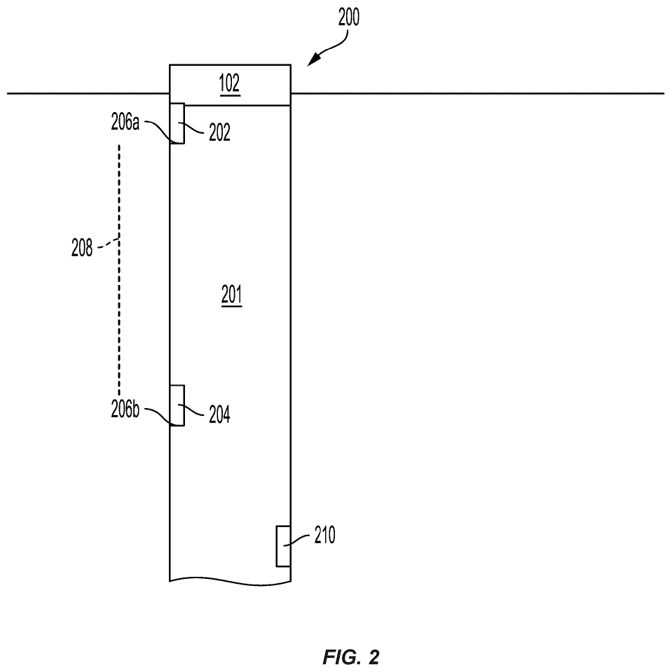

FIG. 2 is a block diagram of a pressure pulse injection system 200 that can inject a pressure pulse into a flowline based on refined fluid properties, such as acoustic velocity, according to some aspects of the present disclosure. In some examples, the pressure pulse injection system 200 may be similar or identical to the pressure pulse injector 102, as described and illustrated with respect to FIG. 1. Additionally or alternatively, the pressure pulse injection system 200 may be separate from, communicatively coupled with, or a combination thereof, with respect to the pressure pulse injector 102. The pressure pulse injection system 200 may be positioned in a flowline 201, which can be or include a wellbore, a pipeline, or other suitable flowline.

In some examples, the pressure pulse injection system 200 can include the pressure pulse injector 102, a first control point 202, and a second control point 204, though the pressure pulse injection system 200 can include any additional, alternative, or fewer components to provide functionality for the pressure pulse injection system 200. The first control point 202 may be or include a first pressure transducer that may detect pressure pulses or other measure pressure at a first location 206a. The second control point 204 may be or include a second pressure transducer that may detect pressure pulses or other measure pressure at a second location 206b. While described as pressure transducers, the first control point 202, the second control point 204, or a combination thereof may be or include a known feature, such as a diameter change, in the flowline 201. The pressure pulse injection system 200 can determine, such as in examples in which at least one of the control points is a known feature of the flowline 201, the first control point 202, the second control point 204, or a combination thereof. Additionally or alternatively, the pressure pulse injection system 200 can identify, such as in examples in which at least one of the control points is a pressure transducer, the first control point 202, the second control point 204, or a combination thereof.

The first control point 202 can be positioned at the first location 206a, and the second control point 204 can be positioned at the second location 206b. The first location 206a may be a known distance 208 from the second location 206b. For example, the known distance 208 may be measured, such as by the pressure pulse injection system 200, between the first location 206a and the second location 206b. In other examples, the known distance 208 may be provided to the pressure pulse injection system 200 to establish the known distance 208 for calculations by the pressure pulse injection system 200.

In some examples, the pressure pulse injection system 200 may use the first control point 202 and the second control point 204, such as the known distance 208 between the first control point 202 and the second control point 204, to determine a sampling rate, to determine one or more parameters about fluid within the flowline 201, or a combination thereof. The pressure pulse injection system 200 can use the known distance 208 to determine the sampling rate for making measurements involving the first control point 202 and the second control point 204. For example, the pressure pulse injection system 200 may have a target resolution of acquired data with respect to the first control point 202 and the second control point 204, and the pressure pulse injection system 200 can adjust a sampling rate, or a rate at which data is collected in the flowline 201, to achieve the target resolution.

The pressure pulse injection system 200 can generate and transmit a pressure pulse that can be directed into the flowline 201. The pressure pulse can pass the first control point 202 and the second control point 204, and the first control point 202 and the second control point 204, or transducers or detectors located at the first control point 202 and the second control point 204, can detect the pressure pulse as the pressure pulse passes the first control point 202 and the second control point 204. The pressure pulse injection system 200 can perform a time-of-flight calculation based on the data detected at the first control point 202 and at the second control point 204 to determine one or more parameters about fluid in the flowline 201. For example, the pressure pulse injection system 200 can determine an acoustic velocity of the fluid in the flowline 201 by performing the time-of-flight calculation.

The one or more parameters about the fluid in the flowline 201 can be used to determine information about an anomaly 210 in the flowline 201. In some examples, the anomaly 210 may be similar or identical to the anomaly 110 as illustrated and described with respect to FIG. 1. For example, the anomaly 210 may be or include a deposition, a blockage, a leak, other anomaly, or any combination thereof. In some examples, the one or more parameters can include the acoustic velocity, which can be used to at least determine a precise, such as within 5% of an exact location, location of the anomaly 210 in the flowline 201.

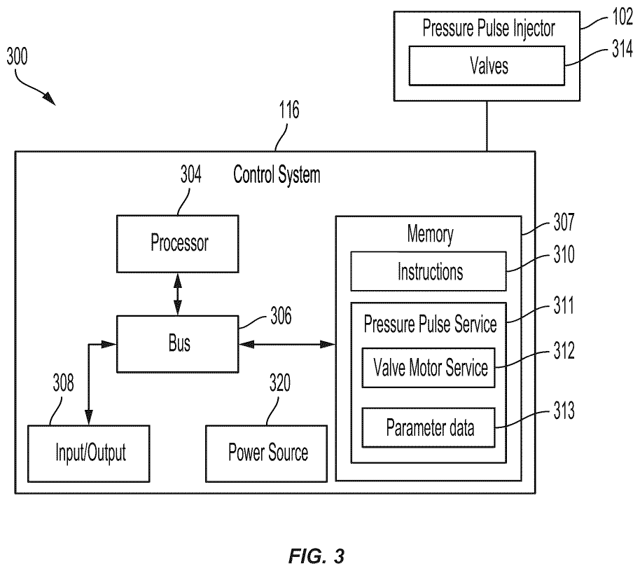

FIG. 3 is a block diagram of a computing system 300 that can be used to refine fluid properties, such as acoustic velocity, for a pressure pulse injection calculation according to some aspects of the present disclosure. The components, such as processor 304, memory 307, power source 320, input/output 308, and so on, illustrated in FIG. 3, may be integrated into a single structure such as within a single housing of the control system 116 and in communication with, or otherwise included in, the pressure pulse injector 102. In some examples, the components illustrated in FIG. 3 can be distributed from one another and may be in electrical communication with each other. And, in other examples, the computing system 300 may be integrated into the pressure pulse injector 102, or vice versa.

The control system 116 can include the processor 304, the memory 307, and a bus 306, among other suitable components for the control system 116. The processor 304 can execute one or more operations for performing a set of operations for facilitating pressure pulse injection in the flowline 201 for determining information about an anomaly in the flowline 201. The processor 304 can execute computer-program instructions 310 stored in the memory 307 to perform the set of operations. The processor 304 can include one processing device or multiple processing devices or cores. Non-limiting examples of the processor 304 can include a field-programmable gate array (“FPGA”), an application-specific integrated circuit (“ASIC”), a microprocessor, and the like.

The processor 304 can be communicatively coupled with the memory 307 via the bus 306. The memory 307 may be or include non-volatile memory and may include any type of memory device that retains stored information when powered off. Some examples of non-volatile forms of the memory 307 may include EEPROM, flash memory, or any other type of non-volatile memory. In some examples, at least part of the memory 307 can include a medium from which the processor 304 can read computer-program instructions 310. A computer-readable medium can include electronic, optical, magnetic, or other storage devices capable of providing the processor 304 with computer-readable instructions or other program code. Some examples of a computer-readable medium may include magnetic disk(s), memory chip(s), ROM, RAM, an ASIC, a configured processor, optical storage, or any other medium from which a computer processor can read computer-program instructions 310. The computer-program instructions 310 can include processor-specific instructions generated by a compiler or an interpreter from code written in any suitable computer-programming language, including, for example, C, C++, C #, Perl, Java, Python, etc.

In some examples, the memory 307 can be a non-transitory computer readable medium and can include computer-program instructions 310. The computer-program instructions 310 can be executed by the processor 304 for causing the processor 304 to perform the set of operations. For example, the processor 304 can execute a pressure pulse service 311, or other suitable computer services, artificial intelligence models, etc., to provide functionality for the control system 116, the pressure pulse injector 102, etc. For example, the processor 304 can cause parameter data 313, such as flowline data, data about fluid in the flowline 201, etc., to be gathered or determined by the pressure pulse injector 102. Additionally or alternatively, the processor 304 can execute a valve motor service 312 to cause valves 314 of the pressure pulse injector 102 to be actuated to control pressurization or fluid flow with respect to the pressure pulse injector 102. In some examples, the processor 304 can execute a control point service 315 to determine, identify, or use two or more control points in the flowline 201 to perform one or more operations or calculations. Additionally or alternatively, the processor 304 can execute the pressure pulse service 311 to perform a set of operations for causing the pressure pulse injector 102 to generate and inject a pressure pulse into the flowline 201, to perform a set of operations for determining parameters about the fluid in the flowline 201, etc. The parameters about the fluid may include an acoustic velocity of the fluid.

In some examples, the control system 116 can include an input/output 308. The input/output 308 can connect to a keyboard, a pointing device, a display, other computer input/output devices or any combination thereof. An operator may provide input using the input/output 308. In some examples, the control system 116 may be fully autonomous and may function without input from an operator. Data relating to the flowline 201, fluid included therein, the pressure pulse to be injected into the flowline 201, the pressure pulse injector 102, or any combination thereof can be displayed to an operator of a wellbore operation through a display that is connected to or is part of the input/output 308. The displayed values can be observed by the operator, or by another suitable user, of the wellbore operation, who can adjust the wellbore operation based on the output. Additionally or alternatively, the control system 116 can automatically control or adjust the wellbore operation, which may be or include a maintenance or repair operation, based on the output, which may be or include an analysis of a reflected pressure pulse received from the flowline 201. In some examples, the analysis may involve receiving input that includes the parameters for the fluid.

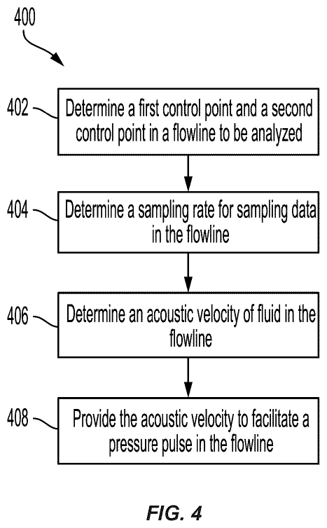

FIG. 4 is a flowchart of a process 400 for automatically refining fluid properties, such as acoustic velocity, for a pressure pulse injection calculation according to some aspects of the present disclosure. At block 402, a first control point, such as the first control point 202, and a second control point, such as the second control point 204, are determined. In some examples, the pressure pulse injection system 200 can determine the first control point and the second control point. Determining the first control point and the second control point can involve selecting the control points or identifying existing control points. For example, the pressure pulse injection system 200 can determine the first control point as a pressure transducer positioned adjacent to the pressure pulse injection system 200. Additionally or alternatively, the pressure pulse injection system 200 can identify a known feature of the flowline as the second control point. In some examples, the first control point, the second control point, or a combination thereof can each be a pressure transducer, the known feature, or a combination thereof. The first control point may be positioned offset from the second control point. For example, the first control point may be positioned longitudinally, with respect to the flowline, apart and at a distance from the second control point. Additionally or alternatively, the first control point may be positioned adjacent to the pressure pulse injection system or other device that can be used to inject a pressure pulse into the flowline.

At block 404, a sampling rate is determined for sampling data in the flowline. The sampling rate can be determined based on a distance between the first control point and the second control point. For example, the pressure pulse injection system can determine a target resolution for measuring data in the flowline. The sampling rate can be adjusted by the pressure pulse injection system to comply with the target resolution.

At block 406, an acoustic velocity, or other suitable parameter, for fluid in the flowline is determined. The acoustic velocity can be determined based on the sampling rate. For example, the pressure pulse injection system can inject a pulse into the flowline, and samples of the pressure pulse can be detected by the pressure pulse injection system. The detected data can be used to perform a time-of-flight calculation or other suitable calculation to determine the acoustic velocity.

At block 408, the acoustic velocity is provided to facilitate a pressure pulse in the flowline. Providing the acoustic velocity may include transmitting the acoustic velocity to the control system 116 or other suitable computing device to be used for interpreting a reflected pressure pulse. For example, a pressure pulse can be injected into the flowline and can be reflected back toward the pressure pulse injection system. The reflected pressure pulse can be interpreted to determine information about an anomaly in the flowline. The acoustic velocity can be used to determine the information about the anomaly.

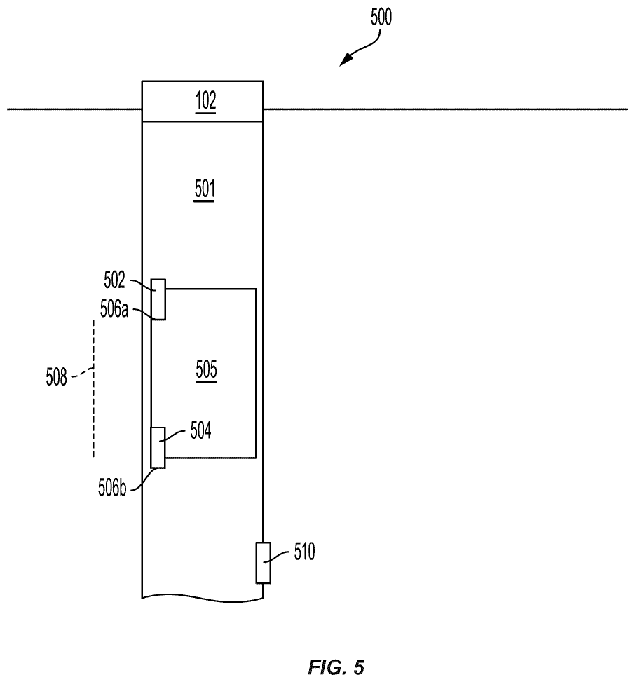

FIG. 5 is a block diagram of a pressure pulse injection system 500 that can inject a pressure pulse into a flowline 501 based on refined fluid properties, such as acoustic velocity, determined using a mobile platform 505 according to some aspects of the present disclosure. In some examples, the pressure pulse injection system 500 may be similar or identical to the pressure pulse injector 102, as described and illustrated with respect to FIG. 1. Additionally or alternatively, the pressure pulse injection system 500 may be separate from, communicatively coupled with, or a combination thereof, with respect to the pressure pulse injector 102. The pressure pulse injection system 500 may be positioned in a flowline 501, which can be or include a wellbore, a pipeline, or other suitable flowline.

In some examples, the pressure pulse injection system 500 can include the pressure pulse injector 102, a first control point 502, and a second control point 504, though the pressure pulse injection system 500 can include any additional, alternative, or fewer components to provide functionality for the pressure pulse injection system 500. The first control point 502 may be or include a first pressure transducer that may detect pressure pulses or other measure pressure at a first location 506a. The second control point 504 may be or include a second pressure transducer that may detect pressure pulses or other measure pressure at a second location 506b. In some examples, the first control point 502 and the second control point 504 may be positioned on the mobile platform 505, which may be or include a pigging tool or other tool that can be moved through the flowline 501. The first control point 502 may be a first pressure transducer positioned on the mobile platform 505 at the first location 506a with respect to the mobile platform 505. Additionally or alternatively, the second control point 504 may be a second pressure transducer positioned on the mobile platform 505 at the second location 506b with respect to the mobile platform 505.

The first control point 502 can be positioned at the first location 506a, and the second control point 504 can be positioned at the second location 506b, and the first location 506a and the second location 506b may be on the mobile platform 505 and variable, such as depending on a position of the mobile platform 505, along the flowline 501. The first location 506a may be a known distance 508 from the second location 506b. For example, the known distance 508 may be measured, such as by the pressure pulse injection system 500, between the first location 506a and the second location 506b. In other examples, the known distance 508 may be provided to the pressure pulse injection system 500 to establish the known distance 508 for calculations by the pressure pulse injection system 500.

In some examples, the pressure pulse injection system 500 may use the first control point 502 and the second control point 504, such as the known distance 508 between the first control point 502 and the second control point 504, to determine a sampling rate, to determine one or more parameters about fluid within the flowline 501, or a combination thereof. The pressure pulse injection system 500 can use the known distance 508 to determine the sampling rate for making measurements involving the first control point 502 and the second control point 504. For example, the pressure pulse injection system 500 may have a target resolution of acquired data with respect to the first control point 502 and the second control point 504, and the pressure pulse injection system 500 can adjust a sampling rate, or a rate at which data is collected in the flowline 501, to achieve the target resolution.

The pressure pulse injection system 500 can generate and transmit a pressure pulse that can be directed into the flowline 501. The pressure pulse can pass the first control point 502 and the second control point 504, and the first control point 502 and the second control point 504, or transducers or detectors located at the first control point 502 and the second control point 504, can detect the pressure pulse as the pressure pulse passes the first control point 502 and the second control point 504. The pressure pulse injection system 500 can perform a time-of-flight calculation based on the data detected at the first control point 502 and at the second control point 504 to determine one or more parameters about fluid in the flowline 501. For example, the pressure pulse injection system 500 can determine an acoustic velocity of the fluid in the flowline 501 by performing the time-of-flight calculation. In some examples, the mobile platform 505 may be translated along the flowline 501 to make multiple measurements of fluid in the flowline 501 at different locations in the flowline 501. For example, multiple different fluids, or combinations of fluids, may be present at different locations in the flowline 501, and the mobile platform 505 may be moved within the flowline 501 to make separate measurements of, for example, acoustic velocity of the multiple different fluids, or combinations of fluids, at the different locations.

The one or more parameters about the fluid in the flowline 501 can be used to determine information about an anomaly 510 in the flowline 501. In some examples, the anomaly 510 may be similar or identical to the anomaly 110 as illustrated and described with respect to FIG. 1. For example, the anomaly 510 may be or include a deposition, a blockage, a leak, other suitable anomaly, or any combination thereof. In some examples, the one or more parameters can include the acoustic velocity, which can be used to at least determine a precise, such as within 5% of an exact location, location of the anomaly 510 in the flowline 501.

In some aspects, systems, methods, and non-transitory computer-readable media for determining parameters, such as acoustic velocity, for a pressure pulse injection into a flowline are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a system comprising: a processor; and a non-transitory computer-readable medium that includes instructions executable by the processor for causing the processor to perform operations comprising: determining a first control point and a second control point in a flowline, the first control point located at a first location adjacent to a device for injecting a pressure pulse in the flowline, the second control point located at a second location that is different than the first location; determining, based on a distance between the first location and the second location, a sampling rate for sampling data in the flowline; determining, based on data sampled in the flowline at the determined sampling rate, an acoustic velocity of fluid in the flowline; and providing the acoustic velocity to the device for transmitting the pressure pulse to facilitate generating and transmitting, based on the acoustic velocity, the pressure pulse into the flowline.

Example 2 is the system of example 1, wherein the device for transmitting the pressure pulse in the flowline comprises a pressure pulse injector that comprises an accumulator and a plurality of valves to facilitate pressurization of a pressure pulse fluid in the accumulator.

Example 3 is the system of example 1, wherein a first pressure transducer is positionable at the first control point, wherein a second pressure transducer is positionable at the second control point, and wherein the sampling rate is selectable based at least in part on a threshold number of measurements between the first pressure transducer and the second pressure transducer.

Example 4 is the system of example 1, wherein a pressure transducer is positionable at the first control point, wherein the second control point is selectable based on a known distinguishing feature of the flowline at the second location, and wherein the sampling rate is selectable based at least in part on a threshold number of measurements between the pressure transducer and the known distinguishing feature of the flowline.

Example 5 is the system of example 1, wherein the first control point or the second control point are positionable at a first end of a mobile platform that is movable through the flowline, and wherein the first location or the second location are variable and based on a position of the mobile platform in the flowline.

Example 6 is the system of example 1, further comprising the device for transmitting the pressure pulse in the flowline, wherein the device for transmitting the pressure pulse in the flowline is a pressure pulse injector that comprises: an accumulator coupled with the flowline, wherein the accumulator is sized to receive a pressure pulse fluid; a plurality of valves coupled with the accumulator to control pressurization of the pressure pulse fluid in the accumulator; and a control system coupled with the plurality of valves and the accumulator to automatically determine, based on the acoustic velocity, information about an anomaly in the flowline.

Example 7 is the system of example 1, wherein the operations further comprise: determining, using a reflection of the pressure pulse, information about an anomaly in the flowline; and outputting the information about the anomaly for facilitating a maintenance or repair operation on the flowline.

Example 8 is a method comprising: determining a first control point and a second control point in a flowline, the first control point located at a first location adjacent to a device for injecting a pressure pulse in the flowline, the second control point located at a second location that is different than the first location; determining, based on a distance between the first location and the second location, a sampling rate for sampling data in the flowline; determining, based on data sampled in the flowline at the determined sampling rate, an acoustic velocity of fluid in the flowline; and providing the acoustic velocity to the device for transmitting the pressure pulse to facilitate generating and transmitting, based on the acoustic velocity, the pressure pulse into the flowline.

Example 9 is the method of example 8, wherein the device for transmitting the pressure pulse in the flowline comprises a pressure pulse injector that comprises an accumulator and a plurality of valves to pressurization a pressure pulse fluid in the accumulator.

Example 10 is the method of example 8, wherein a first pressure transducer is positioned at the first control point, wherein a second pressure transducer is positioned at the second control point, and wherein the sampling rate is selected based at least in part on a threshold number of measurements between the first pressure transducer and the second pressure transducer.

Example 11 is the method of example 8, wherein a pressure transducer is positioned at the first control point, wherein the second control point is selected based on a known distinguishing feature of the flowline at the second location, and wherein the sampling rate is selected based at least in part on a threshold number of measurements between the pressure transducer and the known distinguishing feature of the flowline.

Example 12 is the method of example 8, wherein the first control point or the second control point are positioned at a first end of a mobile platform that is moved through the flowline, and wherein the first location or the second location are variable and based on a position of the mobile platform in the flowline.

Example 13 is the method of example 8, wherein the device for transmitting the pressure pulse in the flowline is a pressure pulse injector that comprises: an accumulator coupled with the flowline, wherein the accumulator is sized to receive a pressure pulse fluid; a plurality of valves coupled with the accumulator to control pressurization of the pressure pulse fluid in the accumulator; and a control system coupled with the plurality of valves and the accumulator to automatically determine, based on the acoustic velocity, information about an anomaly in the flowline.

Example 14 is the method of example 8, further comprising: determining, using a reflection of the pressure pulse, information about an anomaly in the flowline; and performing a maintenance or repair operation on the flowline based at least in part on the information about the anomaly.

Example 15 is a non-transitory computer-readable medium comprising instructions that are executable by a processing device for causing the processing device to perform operations comprising: determining a first control point and a second control point in a flowline, the first control point located at a first location adjacent to a device for injecting a pressure pulse in the flowline, the second control point located at a second location that is different than the first location; determining, based on a distance between the first location and the second location, a sampling rate for sampling data in the flowline; determining, based on data sampled in the flowline at the determined sampling rate, an acoustic velocity of fluid in the flowline; and providing the acoustic velocity to the device for transmitting the pressure pulse to facilitate generating and transmitting, based on the acoustic velocity, the pressure pulse into the flowline.

Example 16 is the non-transitory computer-readable medium of example 15, wherein the device for transmitting the pressure pulse in the flowline comprises a pressure pulse injector that comprises an accumulator and a plurality of valves to facilitate pressurization of a pressure pulse fluid in the accumulator.

Example 17 is the non-transitory computer-readable medium of example 15, wherein a first pressure transducer is positionable at the first control point, wherein a second pressure transducer is positionable at the second control point, and wherein the sampling rate is selectable based at least in part on a threshold number of measurements between the first pressure transducer and the second pressure transducer.

Example 18 is the non-transitory computer-readable medium of example 15, wherein a pressure transducer is positionable at the first control point, wherein the second control point is selectable based on a known distinguishing feature of the flowline at the second location, and wherein the sampling rate is selectable based at least in part on a threshold number of measurements between the pressure transducer and the known distinguishing feature of the flowline.

Example 19 is the non-transitory computer-readable medium of example 15, wherein the first control point or the second control point are positionable at a first end of a mobile platform that is movable through the flowline, and wherein the first location or the second location are variable and based on a position of the mobile platform in the flowline.

Example 20 is the non-transitory computer-readable medium of example 15, wherein the operations further comprise: determining, using a reflection of the pressure pulse, information about an anomaly in the flowline; and outputting the information about the anomaly in the flowline for facilitating a maintenance or repair operation on the flowline.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processor; and
a non-transitory computer-readable medium that includes instructions executable by the processor for causing the processor to perform operations comprising:
determining a first control point and a second control point in a flowline, the first control point located at a first location adjacent to a device for injecting a pressure pulse in the flowline, the second control point located at a second location that is different than the first location;
determining, based on a distance between the first location and the second location, a sampling rate for sampling data in the flowline;
determining, based on data sampled in the flowline at the determined sampling rate, an acoustic velocity of fluid in the flowline; and
providing the acoustic velocity to the device for transmitting the pressure pulse to facilitate generating and transmitting, based on the acoustic velocity, the pressure pulse into the flowline.

2. The system of claim 1, wherein the device for transmitting the pressure pulse in the flowline comprises a pressure pulse injector that comprises an accumulator and a plurality of valves to facilitate pressurization of a pressure pulse fluid in the accumulator.

3. The system of claim 1, wherein a first pressure transducer is positionable at the first control point, wherein a second pressure transducer is positionable at the second control point, and wherein the sampling rate is selectable based at least in part on a threshold number of measurements between the first pressure transducer and the second pressure transducer.

4. The system of claim 1, wherein a pressure transducer is positionable at the first control point, wherein the second control point is selectable based on a known distinguishing feature of the flowline at the second location, and wherein the sampling rate is selectable based at least in part on a threshold number of measurements between the pressure transducer and the known distinguishing feature of the flowline.

5. The system of claim 1, wherein the first control point or the second control point are positionable at a first end of a mobile platform that is movable through the flowline, and wherein the first location or the second location are variable and based on a position of the mobile platform in the flowline.

6. The system of claim 1, further comprising the device for transmitting the pressure pulse in the flowline, wherein the device for transmitting the pressure pulse in the flowline is a pressure pulse injector that comprises:
an accumulator coupled with the flowline, wherein the accumulator is sized to receive a pressure pulse fluid;
a plurality of valves coupled with the accumulator to control pressurization of the pressure pulse fluid in the accumulator; and
a control system coupled with the plurality of valves and the accumulator to automatically determine, based on the acoustic velocity, information about an anomaly in the flowline.

7. The system of claim 1, wherein the operations further comprise:
determining, using a reflection of the pressure pulse, information about an anomaly in the flowline; and
outputting the information about the anomaly for facilitating a maintenance or repair operation on the flowline.

8. A method comprising:
determining a first control point and a second control point in a flowline, the first control point located at a first location adjacent to a device for injecting a pressure pulse in the flowline, the second control point located at a second location that is different than the first location;
determining, based on a distance between the first location and the second location, a sampling rate for sampling data in the flowline;
determining, based on data sampled in the flowline at the determined sampling rate, an acoustic velocity of fluid in the flowline; and
providing the acoustic velocity to the device for transmitting the pressure pulse to facilitate generating and transmitting, based on the acoustic velocity, the pressure pulse into the flowline.

9. The method of claim 8, wherein the device for transmitting the pressure pulse in the flowline comprises a pressure pulse injector that comprises an accumulator and a plurality of valves to pressurization a pressure pulse fluid in the accumulator.

10. The method of claim 8, wherein a first pressure transducer is positioned at the first control point, wherein a second pressure transducer is positioned at the second control point, and wherein the sampling rate is selected based at least in part on a threshold number of measurements between the first pressure transducer and the second pressure transducer.

11. The method of claim 8, wherein a pressure transducer is positioned at the first control point, wherein the second control point is selected based on a known distinguishing feature of the flowline at the second location, and wherein the sampling rate is selected based at least in part on a threshold number of measurements between the pressure transducer and the known distinguishing feature of the flowline.

12. The method of claim 8, wherein the first control point or the second control point are positioned at a first end of a mobile platform that is moved through the flowline, and wherein the first location or the second location are variable and based on a position of the mobile platform in the flowline.

13. The method of claim 8, wherein the device for transmitting the pressure pulse in the flowline is a pressure pulse injector that comprises:
an accumulator coupled with the flowline, wherein the accumulator is sized to receive a pressure pulse fluid;
a plurality of valves coupled with the accumulator to control pressurization of the pressure pulse fluid in the accumulator; and
a control system coupled with the plurality of valves and the accumulator to automatically determine, based on the acoustic velocity, information about an anomaly in the flowline.

14. The method of claim 8, further comprising:
determining, using a reflection of the pressure pulse, information about an anomaly in the flowline; and
performing a maintenance or repair operation on the flowline based at least in part on the information about the anomaly.

15. A non-transitory computer-readable medium comprising instructions that are executable by a processing device for causing the processing device to perform operations comprising:
determining a first control point and a second control point in a flowline, the first control point located at a first location adjacent to a device for injecting a pressure pulse in the flowline, the second control point located at a second location that is different than the first location;
determining, based on a distance between the first location and the second location, a sampling rate for sampling data in the flowline;
determining, based on data sampled in the flowline at the determined sampling rate, an acoustic velocity of fluid in the flowline; and
providing the acoustic velocity to the device for transmitting the pressure pulse to facilitate generating and transmitting, based on the acoustic velocity, the pressure pulse into the flowline.

16. The non-transitory computer-readable medium of claim 15, wherein the device for transmitting the pressure pulse in the flowline comprises a pressure pulse injector that comprises an accumulator and a plurality of valves to facilitate pressurization of a pressure pulse fluid in the accumulator.

17. The non-transitory computer-readable medium of claim 15, wherein a first pressure transducer is positionable at the first control point, wherein a second pressure transducer is positionable at the second control point, and wherein the sampling rate is selectable based at least in part on a threshold number of measurements between the first pressure transducer and the second pressure transducer.

18. The non-transitory computer-readable medium of claim 15, wherein a pressure transducer is positionable at the first control point, wherein the second control point is selectable based on a known distinguishing feature of the flowline at the second location, and wherein the sampling rate is selectable based at least in part on a threshold number of measurements between the pressure transducer and the known distinguishing feature of the flowline.

19. The non-transitory computer-readable medium of claim 15, wherein the first control point or the second control point are positionable at a first end of a mobile platform that is movable through the flowline, and wherein the first location or the second location are variable and based on a position of the mobile platform in the flowline.

20. The non-transitory computer-readable medium of claim 15, wherein the operations further comprise:
determining, using a reflection of the pressure pulse, information about an anomaly in the flowline; and
outputting the information about the anomaly in the flowline for facilitating a maintenance or repair operation on the flowline.
